(19) United States
(12) Patent Application Publication
(10) Pub. No.: US 2018/0335730 A1
(43) Pub. Date: Nov. 22, 2018

(54) IMAGE FORMING APPARATUS

(71) Applicant: CANON KABUSHIKI KAISHA, Tokyo (JP)

(72) Inventor: Hiroki Takayanagi, Abiko-shi (JP)

(21) Appl. No.: 16/048,384

(22) Filed: Jul. 30, 2018

Related U.S. Application Data
(63) Continuation of application No. PCT/JP2017/005794, filed on Feb. 10, 2017.

(30) Foreign Application Priority Data
Feb. 10, 2016 (JP) 2016-023877

(51) Int. Cl. G03G 15/16

(52) U.S. Cl. CPC G03G 15/1615

(57) ABSTRACT

An image forming apparatus capable of stabilizing a feeding behavior of a transfer material while suppressing disturbance of a toner image due to electric discharge is provided.

An image forming apparatus 100 has a constitution in which in a period from after a leading end of a transfer material P with respect to a feeding direction moves in a predetermined distance from a transfer portion N2 toward a fixing portion until a trailing end of the transfer material P with respect to the feeding direction passes through the transfer portion N2, a controller 50 causes a voltage source E3 to apply, to a discharging member 5, a voltage which his larger on an identical polarity side to a charge polarity of toner on an image bearing member 1 than a potential of the discharging member 5 in a period from after the leading end of the transfer material P with respect to the feeding direction passes through the transfer portion N2 until the leading end of the transfer material P moves in the predetermined distance.

### TECHNICAL FIELD

The present invention relates to an image forming apparatus, such as a copying machine, a printer, a facsimile machine, a multi-function machine having functions of these machines, and the like, using an electrophotographic type or an electrostatic recording type.

### BACKGROUND ART

Conventionally, in the image forming apparatus using the electrophotographic type or the like, a toner image formed on an image bearing member by an appropriate process has been transferred onto a transfer(-receiving) material by applying a voltage to a transfer member for forming a transfer portion in contact with the image bearing member. As the transfer member, a transfer roller which is a rotatable roller-type transfer member has been used in many cases. The transfer material passed through the transfer portion is fed to a fixing portion, and is heated and pressed at the fixing portion, so that the toner image is fixed on the transfer material.

Further, in the neighborhood of a side downstream of the transfer portion with respect to a transfer material feeding direction, an electrically discharging member for electrically discharging electric charges of the transfer material from a back side of a toner image carrying surface of the transfer material is provided in some cases (Japanese Laid-Open Patent Application 2000-344374). As the discharging member, an electrically discharging needle which is an electrode member in which a free end opposing the transfer material has a needle shape (cutting blade shape) has been used in many cases. The discharging needle is electrically grounded (connected to the ground) in many cases. By discharging the transfer material passed through the transfer portion, disturbance of the toner image due to electric discharge and the like are suppressed. Further, a technique such that the electric charges are move efficiently removed (discharged) by applying a voltage to the discharging needle has also be known.

### SUMMARY OF THE INVENTION

### Problems to be Solved by the Invention

However, in the case where a distance from the transfer portion to the fixing portion is shorter than a length of the transfer material with respect to the feeding direction, a (transfer material) discharging direction (behavior of the transfer material discharged from the transfer portion) from the transfer portion changes between a portion close to a leading end of the transfer material with respect to the feeding direction and a portion close to a trailing end of the transfer material with respect to the feeding direction in some instances. Typically, the portion close to the leading end of the transfer material is a discharging direction toward a transfer roller, and the portion close to the trailing end of the transfer material is a discharging direction toward the image bearing member.

At that time, at the portion close to the trailing end of the transfer material, disturbance of the toner image occurs due to electric discharge of excessive electric charges of the transfer material in some instances. On the other hand, when a voltage is applied to the discharging needle in order to alleviate a degree of this disturbance of the toner image, the transfer material is electrically charged. For this reason, the portion close to the leading end of the transfer material is subjected to electrically repulsive force and floats. That is, behavior of the transfer material becomes unstable in some instances, such that the transfer material floats without moving along a feeding guide provided downstream of the discharging needle with respect to the transfer material feeding direction.

Accordingly, an object of the present invention is to provide an image forming apparatus capable of stabilizing feeding behavior of a transfer material while suppressing disturbance of a toner image due to electric discharge.

### Means for Solving the Problems

According to an aspect of the present invention, there is provided an image forming apparatus comprising: an image bearing member for bearing a toner image; an intermediary transfer belt onto which the toner image is to be transferred from the image bearing member; a transfer member for forming a transfer portion for transferring the toner image from the intermediary transfer belt onto a transfer material under application of a voltage; a fixing device including a fixing portion for fixing the toner image, transferred on the transfer material, on the transfer material; a discharging member, provided downstream of the transfer portion and upstream of the fixing portion with respect to a transfer material feeding direction, for discharging a surface of the transfer material; a voltage source for applying a voltage to the discharging member; and a controller for controlling the voltage source, wherein a feeding speed of the transfer material at the fixing portion is set so as to be slower than a feeding speed of the transfer material at the transfer portion, and wherein in a case that an image is formed on a specific transfer material which has a basis weight not more than a predetermined value and which has a length, with respect to the transfer material feeding direction, not less than a predetermined length longer than a feeding distance of the transfer material from the transfer portion to the fixing portion, the controller executes an operation in a mode for controlling the voltage applied to the discharging member so that a potential of the discharging member in a period from predetermined timing, after first timing when a leading end of the specific transfer material with respect to the feeding direction reaches the fixing portion and before second timing when an amount of a loop of the specific transfer material formed between the fixing portion and the transfer portion after the leading end of the specific transfer material with respect to the feeding direction reaches a predetermined amount, to third timing when a trailing end of the specific transfer material passes through the transfer portion is identical in polarity to a charge polarity of toner and so that an absolute value of the potential is made larger than an absolute value of a potential of the discharging member applied in a period from passing of the leading end of the specific transfer material with respect to the feeding direction through the transfer portion to the predetermined timing.

According to another aspect of the present invention, there is provided an image forming apparatus comprising: an image bearing member for bearing a toner image; an intermediary transfer belt onto which the toner image is to be transferred from the image bearing member; a transfer member for forming a transfer portion for transferring the toner image from the intermediary transfer belt onto a transfer material under application of a voltage; a fixing device including a fixing portion for fixing the toner image, transferred on the transfer material, on the transfer material; a discharging member, provided downstream of the transfer portion and upstream of the fixing portion with respect to a transfer material feeding direction, for discharging a surface of the transfer material; a voltage source for applying a voltage to the discharging member; and a controller for controlling the voltage source; and detecting means for detecting a position of the transfer material, fed from the transfer portion to the fixing portion, with respect to a direction crossing a surface of the transfer material, wherein in a case that the detecting means detected that the position approached the image bearing member by not less than a predetermined value in a period from passing of a leading end of the transfer material with respect to the feeding direction through the transfer portion until a trailing end of the transfer material with respect to the feeding direction passes the transfer portion, the controller controls the voltage applied to the discharging member so that the voltage applied to the discharging member is identical in polarity to a charge polarity of toner and so that an absolute value of the voltage is made larger than an absolute value of a potential of the discharging member applied in a period from passing of the leading end of the specific transfer material with respect to the feeding direction through the transfer portion until the detecting means detects that the position approached the image bearing member by not less than the predetermined value.

According to another aspect of the present invention, there is provided an image forming apparatus comprising: an image bearing member for bearing a toner image; an intermediary transfer belt onto which the toner image is to be transferred from the image bearing member; a transfer member for forming a transfer portion for transferring the toner image from the intermediary transfer belt onto a transfer material under application of a voltage; a fixing device including a fixing portion for fixing the toner image, transferred on the transfer material, on the transfer material; a discharging member, provided downstream of the transfer portion and upstream of the fixing portion with respect to a transfer material feeding direction, for discharging a surface of the transfer material; a feeding belt, provided downstream of the discharging member and upstream of the fixing portion with respect to the transfer material feeding direction, for feeding the transfer material while attracting the transfer material to a surface thereof; a voltage source for applying a voltage to the discharging member; and a controller for controlling the voltage source, wherein a feeding speed of the transfer material by the feeding belt is set so as to be slower than a feeding speed of the transfer material at the transfer portion, and wherein in a case that an image is formed on a specific transfer material which has a basis weight not more than a predetermined value and which has a length, with respect to the transfer material feeding direction, not less than a predetermined length longer than a feeding distance of the transfer material from the transfer portion to the fixing portion, the controller executes an operation in a mode for controlling the voltage applied to the discharging member so that a potential of the discharging member in a period from predetermined timing, after first timing when a leading end of the specific transfer material with respect to the feeding direction is attracted to the feeding belt and before second timing when an amount of a loop of the specific transfer material formed between the fixing portion and the transfer portion after the leading end of the specific transfer material with respect to the feeding direction reaches a predetermined amount, to third timing when a trailing end of an image region of the specific transfer material passes through the transfer portion is identical in polarity to a charge polarity of toner and so that an absolute value of the potential is made larger than an absolute value of a potential of the discharging member applied in a period from passing of the leading end of the specific transfer material with respect to the feeding direction through the transfer portion to the predetermined timing.

According to another aspect of the present invention, there is provided an image forming apparatus comprising: an image bearing member for bearing a toner image; an intermediary transfer belt onto which the toner image is to be transferred from the image bearing member; a transfer member for forming a transfer portion for transferring the toner image from the intermediary transfer belt onto a transfer material under application of a voltage; a fixing device including a fixing portion for fixing the toner image, transferred on the transfer material, on the transfer material; a discharging member, provided downstream of the transfer portion and upstream of the fixing portion with respect to a transfer material feeding direction, for discharging a surface of the transfer material; a feeding belt, provided downstream of the discharging member and upstream of the fixing portion with respect to the transfer material feeding direction, for feeding the transfer material while attracting the transfer material to a surface thereof; a guiding portion, provided downstream of the discharging member and upstream of the feeding belt with respect to the transfer material feeding direction and constituted by metal which is grounded, for guiding the transfer material; a voltage source for applying a voltage to the discharging member; and a controller for controlling the voltage source, wherein a feeding speed of the transfer material by the feeding belt is set so as to be slower than a feeding speed of the transfer material at the transfer portion, and wherein in a case that an image is formed on a specific transfer material which has a basis weight not more than a predetermined value and which has a length, with respect to the transfer material feeding direction, not less than a predetermined length longer than a feeding distance of the transfer material from the transfer portion to the fixing portion, the controller executes an operation in a mode for controlling the voltage applied to the discharging member so that a potential of the discharging member in a period from predetermined timing, after first timing when a leading end of the specific transfer material with respect to the feeding direction reaches the guiding portion and before second timing when an amount of a loop of the specific transfer material formed between the fixing portion and the transfer portion after the leading end of the specific transfer material with respect to the feeding direction reaches a predetermined amount, to third timing when a trailing end of an image region of the specific transfer material passes through the transfer portion is identical in polarity to a charge polarity of toner and so that an absolute value of the potential is made larger than an absolute value of a potential of the discharging member applied in a period from passing of the leading end of the specific transfer material with respect to the feeding direction through the transfer portion to the predetermined timing.

### Effect of the Invention

According to the present invention, it is possible to stabilize the feeding behavior of the transfer material while suppressing disturbance of the toner image due to the electric discharge.

### BRIEF DESCRIPTION OF THE DRAWINGS

FIG. 1 is a schematic sectional view of an image forming apparatus.

FIG. 2 is a sectional view of a neighborhood of a pre-fixing feeding portion.

FIG. 3 is a sectional view of a neighborhood of a discharging needle in an embodiment.

FIG. 4 is an enlarged plan view of a free end of the discharging needle.

FIG. 5 includes schematic views for illustrating behavior of a transfer material.

FIG. 6 includes schematic views for illustrating floating of the transfer material.

FIG. 7 is a timing chart of a discharging needle voltage in the embodiment.

FIG. 8 is a block diagram showing a schematic control mode of the discharging needle voltage in the embodiment.

FIG. 9 is a sectional view of a neighborhood of a discharging needle in another embodiment.

FIG. 10 is a timing chart of a discharging needle voltage in another embodiment.

FIG. 11 is a block diagram showing a schematic control mode of the discharging needle voltage in another embodiment.

### EMBODIMENTS FOR CARRYING OUT THE INVENTION

In the following, an image forming apparatus according to the present invention will be further specifically described in accordance with the drawings.

### Embodiment 1

### 1. General Structure and Operation of Image Forming Apparatus

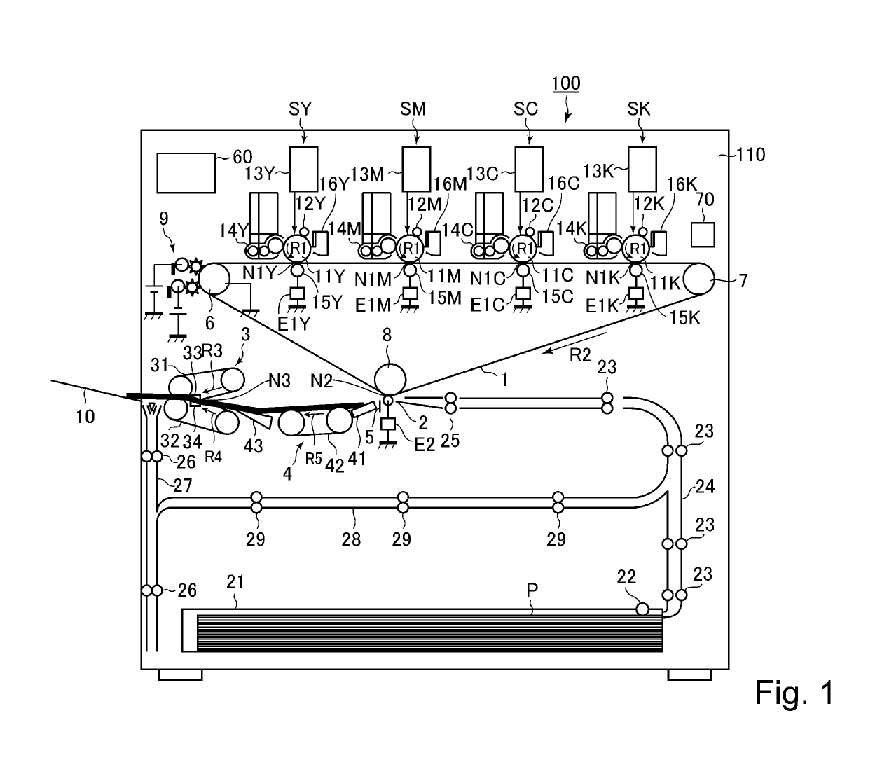

FIG. 1 is a schematic sectional view of an image forming apparatus 100 according to this embodiment. The image forming apparatus 100 in this embodiment is a tandem-type printer capable of forming a full-color image and employing an intermediary transfer type.

The image forming apparatus 100 includes first, second, third and fourth image forming portions SY, SM, SC and SK as a plurality of image forming portions (stations). The first, second, third and fourth image forming portions SY, SM, SC and SK form images of respective colors of yellow (Y), magenta (M), cyan (C) and black (K), respectively. In this embodiment, structures and operations of the respective image forming portions P are substantially the same except that colors of toners used in a developing step described later are different from each other. Accordingly, in the case where distinction is not particularly required, suffixes Y, M, C and K representing elements for associated colors are omitted, and the associated elements will be collectively described. In this embodiment, the image forming portion S is constituted by a photosensitive drum 11, a charging roller 12, an exposure device 13, a developing device 14, a primary transfer roller 15, a drum cleaning device 16 and the like which are described later.

The photosensitive drum 11, as a rotatable first image bearing member, which is a drum-shaped (cylindrical) photosensitive member (electrophotographic photosensitive member) is rotationally driven in an arrow R1 direction (counterdirectionally) in the figure. A surface of the rotating photosensitive drum 11 is electrically charged uniformly to a predetermined polarity (negative polarity in this embodiment) and a predetermined potential by the charging roller 12, as a charging means, which is a roller-type charging member. Light is projected by the exposure device (laser scanner) 13 onto the charged surface of the photosensitive drum 11 through a polygon mirror depending on an image signal of a component color corresponding to each of the image forming portions. By this, an electrostatic latent image (electrostatic image) is formed on the photosensitive drum 11. The electrostatic latent image formed on the photosensitive drum 11 is supplied with toner as a developer by the developing device 14 as a developing means, and is developed (visualized) as a toner image. In this embodiment, on an exposed portion of the photosensitive drum 11 lowered in absolute value of the potential by being exposed to light after being charged uniformly, the toner charged to an identical polarity (negative polarity in this embodiment) to a charge polarity of the photosensitive drum 11 is deposited (reversal development). In this embodiment, a normal charge polarity of the toner which is the charge polarity of the toner during development is the negative polarity.

An intermediary transfer belt 1, as a rotatable second image bearing member, which is an intermediary transfer member constituted by an endless belt is provided so as to oppose the respective photosensitive drums 11 of the respective image forming portions P. The intermediary transfer belt 1 is wound around, as a plurality of stretching rollers (supporting members), a driving roller 6, a tension roller 7 and a back-up roller 8, and is stretched under a predetermined tension. The intermediary transfer belt 1 is rotated (circulated and moved) in an arrow R2 direction (clockwisely) in the figure at peripheral speed (process speed) of 90-400 mm/sec by the driving roller 6. Along a horizontal portion of the intermediary transfer belt 1, the four image forming portions S are provided in series. Inside the intermediary transfer belt 1, the primary transfer rollers 15, as primary transfer means, which are roller-type primary transfer members are disposed correspondingly to the respective photosensitive drums 11. The primary transfer roller 15 is pressed (urged) toward the photosensitive drum 11 via the intermediary transfer belt 1 and forms a primary transfer portion (primary transfer nip) N1 where the photosensitive drum 11 and the intermediary transfer belt 1 are in contact with each other.

The toner image formed on the photosensitive drum 11 as described above is transferred (primary-transferred) onto the intermediary transfer belt 1 at the primary transfer portion N1 by the action of the primary transfer roller 15. During a primary transfer step, to the primary transfer roller 15, from a primary transfer voltage source E1, a primary transfer bias (primary transfer voltage) which is a DC voltage of an opposite polarity (positive polarity in this embodiment) to the normal charge polarity of the toner is applied. For example, during full-color image formation, the toner images of the respective colors of yellow, magenta, cyan and black formed on the respective photosensitive drums 11 are successively transferred superposedly onto the intermediary transfer belt 1. The toner (primary transfer residual toner) remaining on the photosensitive drum 11 after the primary transfer step is removed and collected from the photosensitive drum 11 by the drum cleaning device 16 as a photosensitive member cleaning means.

On an outer peripheral surface side of the intermediary transfer belt 1, at a position opposing the back-up roller 8, a secondary transfer roller 2, as a secondary transfer means, which is a roller-type secondary transfer member is provided. The secondary transfer roller 2 is pressed (urged) toward the back-up roller 8 via the intermediary transfer belt 1 and forms a secondary transfer portion (secondary transfer nip) N2 which is a contact portion between the intermediary transfer belt 1 and the secondary transfer roller 2.

The toner image formed on the intermediary transfer belt 1 as described above is transferred (secondary-transferred) onto a transfer material P, such as paper fed by being sandwiched between the intermediary transfer belt 1 and the secondary transfer roller 2, at the secondary transfer portion N2 by the action of the secondary transfer roller 2. During a secondary transfer step, to the secondary transfer roller 2, from a secondary transfer voltage source E2, a secondary transfer bias (secondary transfer voltage) which is a DC voltage of an opposite polarity (positive polarity in this embodiment) to the normal charge polarity at the toner is applied. The transfer material P is accommodated in an accommodating cassette 21, and after being sent from the accommodating cassette 21 by a pick-up roller 22 or the like, is caused to pass through a feeding path 24 by a feeding roller 23 and is fed to a registration roller 25. Then, by the registration roller 25, the transfer material P is timed to the toner image on the intermediary transfer belt 1, and is supplied to the secondary transfer portion N2. The toner (secondary transfer residual toner) remaining on the intermediary transfer belt 1 after the secondary transfer step is removed and collected from the intermediary transfer belt 1 by a belt cleaning device 9 as an intermediary transfer member cleaning means.

The transfer material P on which the toner image is transferred is, after being discharged from the secondary transfer portion N2, fed to a fixing device 3 as a fixing means by a pre-fixing feeding portion 4. In the neighborhood of a side downstream of the secondary transfer roller 2, a discharging needle (electrically discharging needle) 5 as a discharging member is provided. Details of the pre-fixing feeding portion 4 and the discharging needle 5 will be described later.

The fixing device 3 includes a fixing belt 31 stretched by two stretching rollers and a pressing belt 32 stretched by two stretching rollers. Further, the fixing device 3 includes a heating member 33 provided in contact with the fixing belt 31 on an inner peripheral surface side of the fixing belt 31 and a back-up member 34 provided in contact with the pressing belt 32 on an inner peripheral surface side of the pressing belt 32. The heating member 33 and the back-up member 34 are pressed toward each other via the fixing belt 31 and the pressing belt 32 and form a fixing portion (fixing nip) N3 where the fixing belt 31 and the pressing belt 32 are in contact with each other. The fixing belt 31 and the pressing belt 32 are rotationally driven in an arrow R3 direction (clockwisely) and an R4 direction (counterclockwisely), respectively, and feed the transfer material P at feeding speed of 90-400 mm/sec. Then, the fixing device 3 heats and presses the transfer material P at the fixing portion N3 while sandwiching and feeding the transfer material P between the fixing belt 31 and the pressing belt 32, so that the toner image is fixed (melt-fixed) on the transfer material P. In this embodiment, the image forming apparatus 100 is constituted so that a difference (feeding speed difference) between the feeding speed of the transfer material P at the secondary transfer portion N2 and the feeding speed of the transfer material P at the fixing portion N3 is −1.5 to +1.5 mm/sec. In this embodiment, the feeding speed of the transfer material P at the fixing portion N3 is set so as to be slower than the feeding speed of the transfer material P at the secondary transfer portion N2.

In an operation in a one-side image forming mode in which an image is formed on one side (surface) of the transfer material P, the transfer material P on which the toner image is fixed on the one side and which is discharged from the fixing device 3 is discharged onto a discharge tray 10 provided outside an apparatus main assembly 110 of the image forming apparatus 100. Further, the image forming apparatus 100 of this embodiment is capable of outputting an image by an operation in a double-surface image forming mode in which images are formed on double (both) sides of the transfer material P. In the operation in the double-side image forming mode, the transfer material P on which the toner image is fixed on the one side (first side (surface)) and which is discharged from the fixing device 3 is fed in a reverse feeding path 27 by a reverse feeding roller 26 and is subjected to switch-back, and then is guided to a feeding path 28 for double-side image formation. Thereafter, the transfer material P is fed in the feeding path 28 for double-side image formation by a feeding roller 29 for double-side image formation and after being guided to the feeding pat 24, is supplied to the secondary transfer portion N2 similarly as described above in order to transfer the toner image on a second side (surface) of the transfer material P. The transfer material P on which the toner image is transferred on the second side is subjected to a fixing process by the fixing device 3 similarly as described above and thereafter is discharged onto the discharge tray 10.

Here, as the intermediary transfer belt 1, an intermediary transfer belt having a length such that for example, a peripheral length thereof is 700-2400 mm can be suitably used. In this embodiment, as the intermediary transfer belt 1, an intermediary transfer belt having the peripheral length of 1150 mm was used. Further, in this embodiment, the peripheral speed of the intermediary transfer belt 1 can be 90-400 mm/sec, but is 350 mm/sec in this embodiment. To each of the primary transfer rollers 15 juxtaposed on the inner peripheral surface side of the intermediary transfer belt 1, a primary transfer voltage source E1 is connected. A voltage of a positive polarity is applied to the primary transfer roller 15, so that by an electric field formed at the primary transfer portion N1, the toner image consisting of the negative-polarity toner on the photosensitive drum 11 is transferred onto the intermediary transfer belt 1 in contact with the photosensitive drum 11.

In this embodiment, the intermediary transfer belt 1 is constituted by an endless elastic belt. This intermediary transfer belt 1 includes a base layer (back side (surface) layer), an elastic layer (intermediary layer) and a surface layer. The base layer is such that carbon black is incorporated as an antistatic agent in an appropriate amount in a resin (material) such as polyimide or polycarbonate or in various rubbers and that a thickness thereof is 0.05-0.2 [mm]. The elastic layer is such that carbon back is incorporated in an appropriate amount in various rubbers such as CR rubber and urethane rubber and that a thickness thereof is 0.1-0.300 [mm]. The surface layer is formed of a resin (material) such as an urethane resin or a fluorine-containing resin in a thickness of 0.001-0.020 [mm]. However, the materials constituting the intermediary transfer belt 1 are not limited to the above-described materials.

To the secondary transfer roller 2 disposed on an outer peripheral surface side of the intermediary transfer belt 1, a secondary transfer voltage source E2 is connected. A voltage of 1500-6000 V in positive polarity is applied to the secondary transfer roller 2, so that current of 20-100 μA flows. By this, onto the transfer material P in contact with the intermediary transfer belt 1, the toner image consisting of the toner of the negative layer on the intermediary transfer belt 1 is transferred.

### 2. Pre-Fixing Feeding Portion

Next the pre-fixing feeding portion 4 will be described. Incidentally, in the following description, “upstream” and “downstream” mean upstream and downstream, respectively, with respect to a feeding direction of the toner P in the case of unless otherwise stated. Further, in the following description, “leading end” and “trailing end” means a leading end and a trailing end, respectively, of the transfer material P with respect to the feeding direction of the transfer material P in the case of unless otherwise stated.

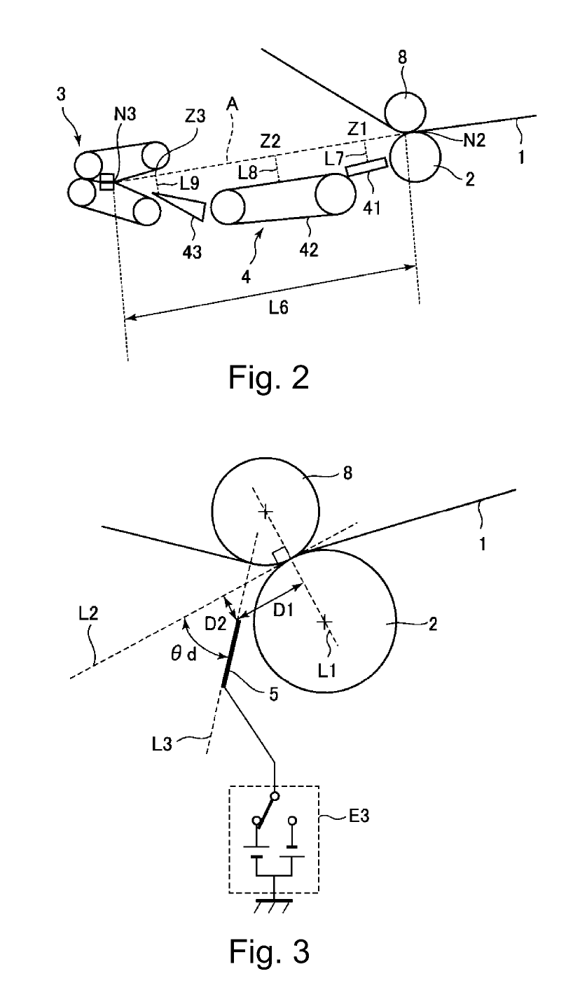

FIG. 2 is a sectional view of a neighborhood of the pre-fixing feeding portion 4 as seen in a direction (rotational axis directions of the photosensitive drum 1 and the stretching rollers for the intermediary transfer belt 1) substantially perpendicular to the feeding direction of the transfer material P. In this embodiment, the pre-fixing feeding portion 4 is constituted by including a front guide 41, a feeding belt 42 and a rear guide 43 which are provided in a named order from an upstream side toward a downstream side. The front guide 41 guides the transfer material P discharged from the secondary transfer portion N2 and introduces the transfer material P to the feeding belt 42. The feeding belt 32 is stretched by two stretching rollers and is rotationally driven in an arrow R5 (counterclockwise) direction in FIG. 1, and feeds the transfer material P, contacting the surface of the feeding belt 42, toward the fixing device 3. In this embodiment, the feeding belt 42 is constituted so as to attract the discharged transfer material P to the surface thereof. Specifically, in the feeding belt 42, a plurality of holes are formed so as to such air from an inside of the feeding belt 42. Inside the feeding belt 42, a suction means for sucking air to the inside of the feeding belt 42. Further, a feeding speed of the transfer material P by the feeding belt 42 is set so as to be slower than a feeding speed of the transfer material P at the secondary transfer portion N2. The rear guide 43 guides the transfer material P fed by the feeding belt 42 and introduces the transfer material P toward the fixing portion N3.

A positional relationship among the pre-fixing feeding portion 4, the secondary transfer portion N2 and the fixing portion N3 is as follows. A rectilinear line (broken line in the figure) drawn from a downstream-side end portion of the secondary transfer portion N2 to an upstream-side end portion of the fixing portion N3 is a nip line A. A length of this nip line A, i.e., a distance L6 from the downstream-side end portion of the secondary transfer portion N2 to the upstream-side end portion of the fixing portion N3 is 160-190 mm. A closest distance L7 between the nip line A and the front guide 41 is 1-6 mm. When a closest position, on the nip line A, to the front ground 41 is a point Z1, a distance on the nip line A from the secondary transfer portion N2 to the point Z1 is 1-5 mm. A closest distance L8 between the nip line A and the feeding belt 42 is 15-19 mm. When a closest position, on the nip line A, to the feeding belt 42 is a point Z2, a distance on the nip line A from the secondary transfer portion N2 to the point Z2 is 70-80 mm. A closest distance L9 between the nip line A and the rear guide 43 is 8-13 mm. When a closest position, on the nip line A, to the rear ground 43 is a point Z3, a distance on the nip line A from the secondary transfer portion N2 to the point Z3 is 140-155 mm.

### 3. Discharging Needle

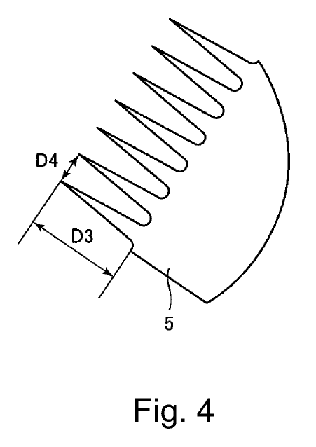

Next, the discharging needle 5 in this embodiment will be described. FIG. 3 is a sectional view of a neighborhood of the discharging needle 5 as seen in a direction (rotational axis directions of the photosensitive drum 1 and the stretching rollers for the intermediary transfer belt 1) substantially perpendicular to the feeding direction of the transfer material P. Further, FIG. 4 is an enlarged plan view of a free end of the discharging needle 5.

In this embodiment, in the neighborhood of the secondary transfer portion N2, as a discharging member, the discharging needle 5 which is an electrode member having the free end, opposing the transfer material P, which has a needle shape (saw tooth shape) is provided. In this embodiment, the discharging needle 5 is disposed close the intermediary transfer belt 1 and the secondary transfer roller 2 so as not to contact the intermediary transfer belt 1 and the secondary transfer roller 2 on a side downstream of the secondary transfer roller 2 and upstream of the front guide 41 with respect to the feeding direction of the transfer material P. Further, to the discharging needle 5, a discharging voltage source E3 is connected. As described later, in this embodiment, the discharging voltage source E3 includes a negative polarity outputting portion and a positive polarity outputting portion, and is capable of applying a DC voltage of the negative polarity and a DC voltage of the positive polarity to the discharging needle 5 in a switching manner. Further, the discharging needle 5 is capable of electrically discharging the transfer material P from a back side, to a toner image carrying surface, of the transfer material P discharged from the secondary transfer roller N2. Here, the (electrical) discharging does not mean only that electric charges are completely removed, but includes that at least a part of the electric charges is removed (neutralized by electric charges of an opposite polarity).

More specifically, as shown in FIG. 3, a distance (closest distance) D1 between a line L1, connecting a rotation center of the secondary transfer roller 2 and a rotation center of the back-up roller, and the free end of the discharging needle 5 is 10-15 mm. Further, a distance (closest distance) D2 between a line L2, perpendicular to the line L1 and passing through a contact point between the secondary transfer roller 2 and the intermediary transfer belt 1 extended around the back-up roller 8, and the free end of the discharging needle 5 is 1-4 mm. Further, a slope θd of the discharging needle 5 with respect to the line L2 is 20-60° (inclination of the discharging needle 5 in a direction spaced away from the line L2 with movement of the transfer material P toward the downstream side of the feeding direction).

Further, as shown in FIG. 4, the discharging needle 5 has a free end shape which is the needle shape (saw tooth shape), and one needle is 3±0.5 mm in length D3 from a base portion to a free end and is 1±0.5 mm in distance D4 between adjacent free ends.

Incidentally, a length of the discharging needle 5 with respect to a longitudinal direction (direction substantially perpendicular to the feeding direction of the transfer material P) is not less than a length of a transfer material P, having a longest length in the longitudinal direction, of transfer materials P on which the image forming apparatus 100 of this embodiment is capable of forming images. That is, the transfer materials P which are discharged from the secondary transfer portion N2 and which have any size pass through within a range of the length of the discharging needle 5 in the longitudinal direction.

### 4. Behavior of Transfer Material

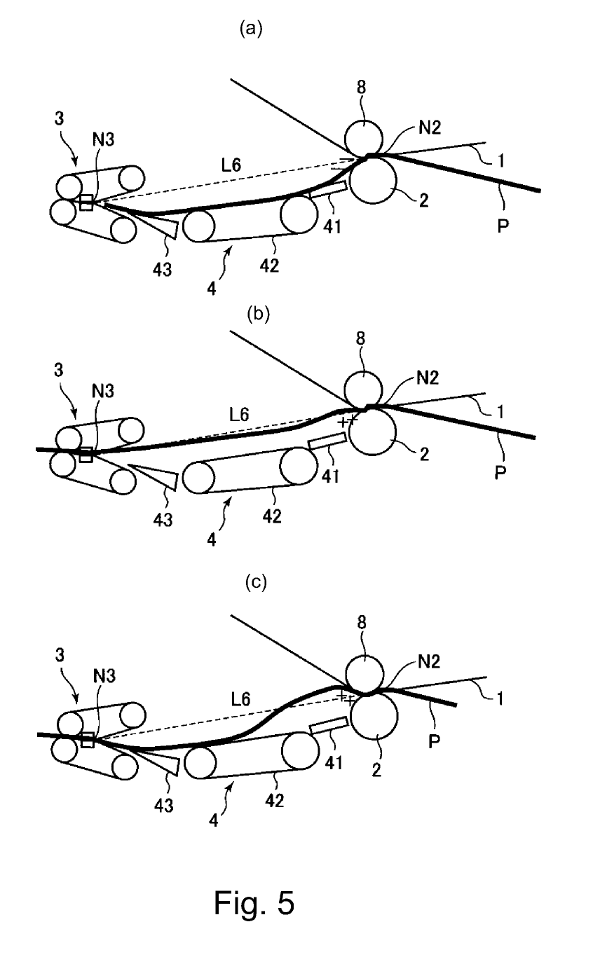

Next, behavior of the transfer material P between the secondary transfer portion N2 and the fixing portion N3 will be described. FIG. 5 includes schematic views showing the behavior. In FIG. 5, illustration of the discharging needle 5 is omitted.

First, the transfer material P immediately after passing through the secondary transfer portion N2 (before reaching the fixing portion N3) moves along the pre-fixing feeding portion 4 (the front guide 41, the feeding belt 42 and the rear guide 43 and forms a loop shape as shown in part (a) of FIG. 5. In this embodiment, a constitution in which an outer diameter of the secondary transfer roller 2 is larger than an outer diameter of the back-up roller 8 is employed. That is, in this embodiment, the image forming apparatus 100 includes the back-up roller 8 which is provided in contact with an inner surface of the intermediary transfer belt 1 and which forms the secondary transfer portion N2 while opposing the secondary transfer roller 2 through the intermediary transfer belt 1 sandwiched between the back-up roller 8 and the secondary transfer roller 2. Further, the outer diameter of the back-up roller 8 is smaller than the outer diameter of the secondary transfer roller 2. For this reason, the leading end of the transfer material P is easily fed along the secondary transfer roller 2 side (downwardly) where curvature is small.

Next, in the case where after the transfer material P reaches the fixing portion N3, the feeding speed of the transfer material P at the state N2 is faster than the feeding speed of the transfer material P at the fixing portion N3, the behavior of the transfer material P is as follows. That is, as shown in part (b) of FIG. 5, the transfer material P floats from the pre-fixing feeding portion 4 (the front guide 41, the feeding belt 42 and the rear guide 43) while eliminating the above-described loop, so that a discharging direction of the transfer material P from the secondary transfer portion N2 is oriented toward the intermediary transfer belt 1.

On the other hand, in the case where after the transfer material P reaches the fixing portion N3, the feeding speed of the transfer material P at the fixing portion N3 is faster than the feeding speed of the transfer material P at the secondary transfer portion N2, the behavior of the transfer material P is as follows. That is, as shown in part (c) of FIG. 5, the above-described loop becomes excessive and the transfer material P floats from the pre-fixing feeding portion 4 (the front guide 41, the feeding belt 42 and the rear guide 43), so that the discharging direction of the transfer material P from the secondary transfer portion N2 is also oriented toward the intermediary transfer belt 1.

In this embodiment, the voltage of the positive polarity is applied to the secondary transfer roller 2. For this reason, in the case where the discharging direction of the transfer material P from the secondary transfer portion N2 is oriented toward the secondary transfer roller 2, when the transfer material P passes through the secondary transfer portion N2, electric discharge generates by a gap between the transfer material P and the back-up roller 8, so that the transfer material P is charged to the negative polarity side. On the other hand, in the case where the discharging direction of the transfer material P from the secondary transfer portion N2 is oriented toward the intermediary transfer belt 1, when the transfer material P passes through the secondary transfer portion N2, electric discharge generates by a gap between the transfer material P and the secondary transfer roller 2, so that the transfer material P is charged to the positive polarity side.

That is, as shown in FIG. 5, even in the case where either of the feeding speed of the transfer material P at the secondary transfer portion N2 or the feeding speed of the transfer material P at the fixing portion N3 is large, the discharging direction of the transfer material P from the secondary transfer portion N2 after the transfer material P reached the fixing portion N3 is oriented toward the intermediary transfer belt 1. For that reason, after the transfer material P reached the fixing portion N3, a charging state of the transfer material P changes from the negative polarity to the positive polarity.

This phenomenon becomes conspicuous with a longer length of the transfer material P with respect to the feeding direction. Here, the behavior was checked using, as the transfer material P, papers (“OK Price” (basis weight: 52 g/m²) and “OK Top Coat” (basis weight: 128 g/m²), manufactured by Oji Paper Co., Ltd.) which are 142-762 mm in length with respect to the feeding direction.

### 5. Control of Discharging Voltage

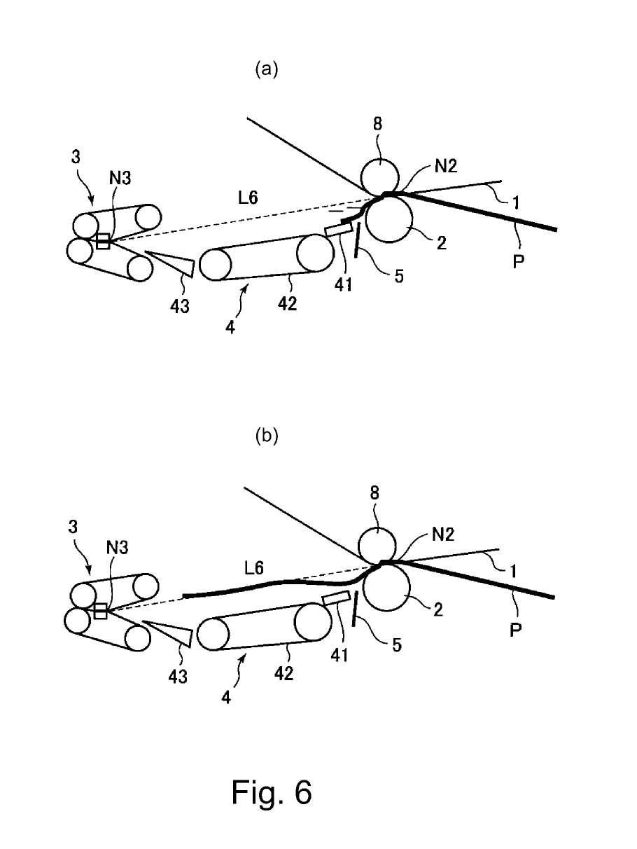

Next, control of a voltage (discharging needle voltage) applied to the discharging needle 5 will be described. FIG. 6 includes schematic views for illustrating a floating state of the transfer material P.

When the transfer material P in a state of part (b) or (c) of FIG. 5 described above is separated from the intermediary transfer belt 1, in order to alleviate excessive positive(-polarity) electric charges, negative(-polarity) electric charges enter the toner image carrying surface side, so that toner image disturbance occurs in some instances.

At this time, when the voltage of the negative polarity is applied to the discharging needle 5, the excessive positive electric charges can be efficiently discharged, so that the toner image disturbance can be alleviated. However, as shown in part (a) of FIG. 6, the transfer material P before reaching the fixing portion N3 is discharged from the secondary transfer portion N2 toward a side close to the secondary transfer roller 2 and is charged to the negative polarity. For that reason, when the voltage of the negative polarity is applied to the discharging needle 5 in this state, as shown in part (b) of FIG. 6, the transfer material P and the discharging needle 5 are electrostatically repelled by each other, so that the transfer material P floats in some instances. By this, the transfer material P collides with an unshown peripheral member, so that the toner image disturbance occurs and further the leading end side of the transfer material P is folded and then the transfer material P is discharged from the fixing portion N3 in some instances.

Therefore, in this embodiment, in a period from movement of the leading end of the transfer material P by a predetermined distance from the secondary transfer portion N2 toward the fixing portion until the trailing end of the transfer material P passes through the secondary transfer portion N2, the following voltage is applied to the discharging needle 5. That is, a voltage larger on an identical polarity side to the normal charge polarity of the toner than a potential of the discharging member 5 in a period from passing of the leading end of the transfer material P through the secondary transfer portion N2 until the leading end of the transfer material P moves by the predetermined distance described above is applied from the discharging voltage source E3 to the discharging member 5. Typically, the period in which the leading end of the transfer material P moves from the secondary transfer portion N2 toward the fixing portion N3 by the above-described predetermined distance is a period in which the leading end of the transfer material P reaches the fixing portion N3 from the secondary transfer portion N2. In this embodiment, this control is carried out by a CPU 50 (FIG. 8) as a controller provided in the apparatus main assembly 110. In the following, this will be further described in detail.

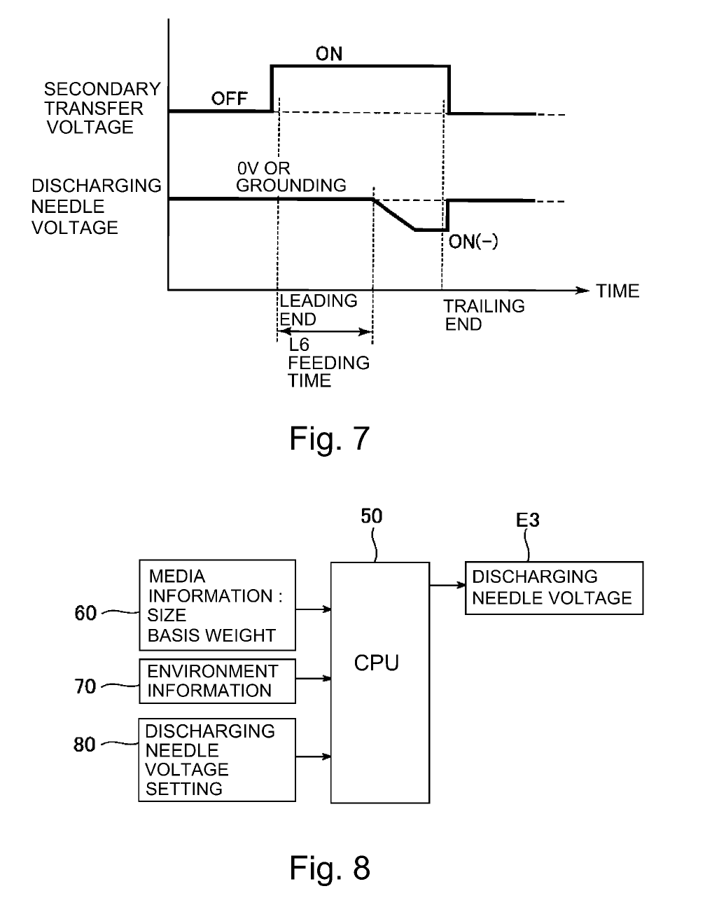

FIG. 7 is a timing chart of the voltage (secondary transfer voltage) applied to the secondary transfer roller 5 and the voltage (discharging needle voltage) applied to the discharging needle 5 in this embodiment. Further, FIG. 8 is a block diagram showing a schematic control mode of the discharging needle voltage in this embodiment.

In this embodiment, in a period in which the leading end of the transfer material P discharged from the secondary transfer portion N2 moves in the distance L6 from the secondary transfer portion N2 to the fixing portion N3, the discharging needle voltage is made 0 V or the discharging needle 5 is placed in a grounding state. Incidentally, in this embodiment, also when the transfer material P does not exist between the secondary transfer portion N2 and the fixing portion N3, the discharging needle voltage is made 0 V or the discharging needle 5 is placed in the grounding state. Then, after the leading end of the transfer material P discharged from the secondary transfer portion N2 moves correspondingly to the distance L6 between the secondary transfer portion N2 and the fixing portion N3, to the discharging needle 5, the negative voltage is applied while gradually increasing an absolute value thereof. In this embodiment, the absolute value of the discharging needle voltage is stepwisely increased every feeding distance of 5-15 mm of the transfer material P, and is finally made a value of a voltage, for discharging, determined in advance as described later (herein, also referred to as a “discharging voltage”). In this embodiment, the discharging voltage applied after the movement of the transfer material P by a distance corresponding to the distance L6 may preferably be −0.5 kV to −4 kV. Thus, in this embodiment, the discharging needle voltage is gradually increased on the identical polarity side to the charge polarity of the toner on the intermediary transfer belt 1. Further, after the trailing end of the transfer material P passed through the secondary transfer portion N2, the discharging needle voltage is made 0 V or the discharging needle 5 is placed in the grounding state.

The reason why the potential of the discharging needle 5 changes after the transfer material P moves in the distance corresponding to the distance L6 is as follows. That is, the leading end of the transfer material P reaches the neighborhood of the fixing portion N3 if after the transfer material P moved in a distance corresponding to at least the distance L6, the leading end of the transfer material P reaches the neighborhood of the fixing portion N3, so that the discharging direction of the transfer material P from the secondary transfer portion N2 is gradually changed toward the intermediary transfer belt 1.

The reason why the absolute value of the discharging needle voltage is gradually increased is as follows. That is, a neighborhood of a point of time of the movement of the transfer material P by the distance corresponding to the distance L6 is timing when the charging state of the transfer material P is changed from a negative polarity state to a positive polarity state. For that reason, the behavior of the transfer material P can stabilize when the discharging needle voltage is gradually changed toward a final discharging voltage value as in this embodiment more than when the discharging needle voltage is switched to the final discharging voltage value in a step function manner.

Table 1 shows setting of the discharging needle voltage in this embodiment. In this embodiment, as shown in Table 1, the final discharging voltage value is changed depending on an environment (absolute water content in this embodiment), a basis weight of the transfer material P and whether an image formation side (surface) is a first side (surface) or a second side (surface).

TABLE 1

| | | | | Environment | | |
|---|---|---|---|---|---|---|
| | | | | NL | NN | HH |
| | | | | Temperature (° C.) | | |
| | | | | 23° C. | 23° C. | 30° C. |
| | | | | Humidity (%) | | |
| | | | | 5% | 50% | 80% |
| | | | | Absolute Water Content | | |
| | | | | (g/kg—DryAir) | | |
| | | | | 0.907 g | 9.184 g | 22.734 g |
| Basis | 52-127 | 1ST | Before L6 | 0 kV or | 0 kV or | 0 kV or |
| Wight | | Side | After L6 | Grounging | Grounging | Grounging |
| (g/m²) | | | | −2 kV | −1.5 kV | 1.0 kV |
| | | 2ND | Before L6 | 0 kV or | 0 kV or | 0 kV or |
| | | Side | | Grounging | Grounging | Grounging |
| | | | After L6 | −2.5 kV | −2.0 kV | −1.5 kV |
| | 128-300 | 1ST | Before L6 | 0 kV or | 0 kV or | 0 kV or |
| | | Side | | Grounging | Grouning | Grounging |
| | | | After L6 | −1.5 kV | −1.0 kV | −0.5 kV |
| | | 2ND | Before L6 | 0 kV or | 0 kV or | 0 kV or |
| | | Side | | Grounging | Grounging | Grounging |
| | | | After L6 | −2 kV | −1.5 kV | −1.0 kV |

Thus, in this embodiment, the absolute value of the discharging voltage is changed depending on the environment. Particularly, in this embodiment, an absolute value of the discharging voltage in the case where a humidity of the environment is a second value larger than a first value is made smaller than an absolute value of the discharging voltage in the case where the humidity of the environment is the first value. Further, in this embodiment, the absolute value of the discharging voltage is changed depending on the basis weight of the transfer material P. Particularly, in this embodiment, an absolute value of the discharging voltage in the case where the basis weight of the transfer material P is a second basis weight larger than a first basis weight is made smaller than an absolute value of the discharging voltage in the case where the basis weight of the transfer material P is the first basis weight.

That is, on a low humidity side, attenuation of excessive electric charges of the transfer material P is slow and the electric discharge is liable to occur, and therefore, the absolute value of the discharging voltage of the transfer material P on the low humidity side is made larger than that on a high humidity side.

Further, when the basis weight of the transfer material P is large, rigidity of the transfer material P is high and therefore the states of parts (b) and (c) of FIG. 5 are not readily formed, so that the absolute value of the discharging voltage is made smaller in the case where the basis weight of the transfer material P is large than in the case where the basis weight of the transfer material P is small.

Further, the transfer material P passes once through the fixing portion N3 in the case of image formation on a second side (double-side image forming mode) of the transfer material P and is dried more than in the case of image formation on a first side (one-side image forming mode, on the first side of the double-side image forming mode) of the transfer material P, and therefore, the attenuation of the excessive electric charges of the transfer material P is slow and the electric discharge is liable to occur. For that reason, the absolute value of the discharging voltage on the second side of the transfer material P is made larger than the absolute value of the discharging voltage on the first side of the transfer material P.

As shown in FIG. 8, information (media information) on the transfer material P used in the image formation is inputted to the CPU 50 by an instruction of an operator for an operating potion 60 provided in the apparatus main assembly 110, for example. In this embodiment, as the media information, information of a size of the transfer material P and information of the basis weight of the transfer material P are inputted to the CPU 50. Incidentally, the information of the basis weight of the transfer material P is not required to be the basis weight itself, but may also be information, such as a kind of the transfer material P (for example, attribute such as coated paper, plain paper or thin paper, or maker or product number), capable of specifying the basis weight with sufficient accuracy. Further, the media information may also be inputted from an operating portion of an external device communicatably connected with the apparatus main assembly 110 or from a sensor for detecting the information of the size of the transfer material P or the information of the basis weight of the transfer material P. Further, the information of the environment is inputted to the CPU 50 from a temperature and humidity sensor 70 as an environment detecting means for detecting at least one of a temperature and a humidity of at least one of an inside and an outside of the apparatus main assembly 110. Further, the CPU 50 is capable of discriminating whether the image formation side is the first side or the second side, from a sequence of an image forming operation. The CPU 50 determines the discharging needle voltage on the basis of the information of the environment, the media information and the information on whether the image formation side is the first side or the second side by making reference to information of setting of the discharging needle voltage which is stored in a memory 80 as an information storing means provided in the apparatus main assembly 110 and which is as shown in Table 1. Then, the CPU 50 controls the discharging voltage source E3 on the basis of the determined setting of the discharging needle voltage and causes the image forming portion to execute the image formation.

Incidentally, in this embodiment, the discharging voltage value is changed depending on each of the environment, the basis weight of the transfer material P and whether the image formation side is the first side or the second side, but can also be changed depending on at least one of these factors. Further, in this embodiment, the discharging voltage value is changed depending on the absolute water content as the information of the humidity of the environment, but may also be changed depending on relative humidity. Further, the temperature and the humidity correlate with each other, and therefore, the discharging voltage value may also be changed depending on the temperature of the environment as desired.

Further, only in the case where the length of the transfer material P with respect to the feeding direction is not less than the distance from the secondary transfer portion N2 to the fixing portion N3, i.e., only in the case where when the leading end of the transfer material P reaches the fixing portion N3, the trailing end of the transfer material P is in a state in which the trailing end of the transfer material P does not pass through the secondary transfer portion N2, the control in this embodiment may also be carried out. In the case where the length of the transfer material P with respect to the feeding direction is less than the distance from the secondary transfer portion N2 to the fixing portion N3, for example, the discharging needle voltage can be made 0 V or the discharging needle 5 can be placed in the grounding state.

Specifically, in this embodiment, the image forming apparatus 100 is constituted so as to be capable of forming images on a transfer material P1 and a transfer material P2 which are described below. The transfer material P1 is a transfer material P such that the length of the transfer material P with respect to the feeding direction is not less than a predetermined length longer than the feeding distance of the transfer material P from the secondary transfer portion N2 to the fixing portion N3, and the transfer material P2 is a transfer material P2 longer in length of the transfer material P with respect to the feeding direction than the transfer material P1. Here, the transfer material P1 and the transfer material P2 are of the same kind (the same rigidity and the same basis weight of the transfer material P). Further, the CPU 50 carries out the following control in the case where the images are formed on at least the transfer material P1 and the transfer material P2. That is, during passing of the transfer material P through the secondary transfer portion N2, in the case where the predetermined time has elapsed from passing of the leading end of the transfer material P through the secondary transfer portion N2, the discharging needle voltage is changed from 0 V (or the grounding state) to the discharging voltage (a voltage increased to the identical polarity side to the charge polarity of the toner). In this embodiment, this predetermined time is set so as to satisfy the following. That is, predetermined timing when the discharging needle voltage is changed is set at timing after the leading end of the transfer material P is attracted to the feeding belt 42 and before an amount of a loop of the transfer material P formed between the secondary transfer portion N2 and the fixing portion N3 after the leading end of the transfer material P reaches the fixing portion N3 reaches a predetermined amount. Here, the amount of the loop is a length of the transfer material P, with respect to the feeding direction, existing between the secondary transfer portion N2 and the fixing portion N3.

That is, in this embodiment, the CPU 50 carries out control so that at the time of a lapse of the above-described predetermined time, the discharging needle voltage is changed from 0 V (or the grounding state) to the discharging voltage (the voltage increased to the identical polarity side to the charge polarity of the toner). In this embodiment, the timing when the discharging needle voltage is changed is controlled so that in the case where the kinds of the transfer materials P are the same and are different in length with respect to the feeding direction, the timing for the transfer material P1 and the timing for the transfer material P2 are substantially the same when the timing is considered on a leading end basis. That is, lengths of the transfer materials P1 and P2 from the leading ends of the transfer materials P1 and P2 to the secondary transfer portion N2 when the discharging voltage is applied are set so as to be substantially the same.

Here, even when the transfer material P having the feeding direction length not less than a specific length is used, in the case where the rigidity of the transfer material P is large, a change (an amount in which the discharging direction of the transfer material P from the secondary transfer portion N2 is oriented toward the intermediary transfer belt 1) in discharging direction of the transfer material P is small. In this case, an image defect due to a change in attitude of the transfer material P does not readily generate. For this reason, even when the transfer material P having the feeding direction length not less than the specific length is used, in the case where the kind of the transfer material P is a specific paper kind (for example, in the case where rigidity of paper is larger than a predetermined value), the control in this embodiment may also be not carried out. In other words, the control in this embodiment may also be carried out in the case where the feeding direction length of the transfer material P is not more than the specific length and the kind of the transfer material P is a specific paper kind (in the case where rigidity of paper is not more than the predetermined value). That is, in the case where an image is formed on a specific transfer material P as described below, the CPU 50 is capable of executing an operation in a mode in which the discharging needle voltage is changed in accordance with this embodiment. The specific transfer material P is a transfer material P such that the basis weight of the transfer material P is not more than a predetermined value and the length of the transfer material P with respect to the feeding direction is not less than the predetermined length longer than the feeding distance of the transfer material P from the secondary transfer portion N2 to the fixing portion N3.

Incidentally, in this embodiment, the CPU 50 carries out control so that during passing of at least a maximum image forming region (image region, image portion) of the transfer material P through the secondary transfer portion N2, the discharging needle voltage is changed from 0 V (or the change state) to the discharging voltage (the voltage increased to the identical polarity side to the charge polarity of the toner). That is, in this embodiment, the predetermined timing when the discharging needle voltage is changed form 0 V 8or the grounding state) to the discharging voltage is set at a period until the trailing end of the image region of the above-described specific transfer material P with respect to the feeding direction passes through the secondary transfer portion N2. This is because the image defect due to electric discharge to the maximum image forming region of the transfer material P is suppressed. Further, timing when the discharging needle voltage is returned to 0 V or the grounding state may preferably be after passing of the trailing end of the maximum image forming region of the transfer material P through the secondary transfer portion N2 or after passing of the trailing end of the maximum image forming region of the transfer material P through a closest position to the discharging needle 5. From a viewpoint of suppressing the image defect due to the electric discharge, a constitution in which the discharging needle voltage is returned to 0 V or the grounding state after the trailing end of the transfer material P passed through the closest position to the discharging needle 5 may preferably be employed.

Further, as described above, the predetermined timing when the discharging needle voltage is changed from 0 V (or the grounding state) to the discharging voltage (the voltage increased to the identical polarity side to the charge polarity of the toner) can be set at timing after the transfer material P is attracted to the feeding belt 42. However, from a viewpoint of a feeding property of the transfer material P, this predetermined timing may preferably be set after the leading end of the transfer material P reached the fixing portion N3. However, even when the leading end of the transfer material P reached the fixing portion N3, unless the feeding property of the transfer material P becomes unstable, the discharging needle voltage may also be changed.

For example, after the leading end of the transfer material P reached (is attracted to) the feeding belt 42, the transfer material P is fed while being attracted and held and therefore the feeding property is stable. For this reason, after the leading end of the transfer material P reached the feeding belt 42, the discharging needle voltage may also be changed from 0 V (or the grounding state) to the discharging voltage (the voltage increased to the identical polarity side to the charge polarity of the toner). Further, in this embodiment, the front guide 41 as a guiding portion is constituted by metal (metal plate) which is grounded. In this case, when the leading end of the transfer material P reached the front guide 41, the transfer material P is electrostatically attracted to the front guide 41 and is guided by the front guide 41. For this reason, the feeding property is stable. In such a case, after the leading end of the transfer material P reached the front guide 41, the discharging needle voltage may also be changed. On the other hand, when the discharging needle voltage is changed before the leading end of the transfer material P reaches the front guide 41, the feeding property of the transfer material becomes unstable. For this reason, in a preferred example, the discharging needle voltage may preferably be changed after the leading end of the transfer material P reached (is attracted to) the feeding belt 42. Here, a point of time when the leading end of the transfer material P reaches the front guide 41 refers to a point of time when the leading end of the transfer material P moves in a shortest distance between the secondary transfer portion N2 and the front guide 41 after passing through the secondary transfer portion N2. Similarly, a point of time when the leading end of the transfer material P reaches the front guide 41 refers to a point of time when the leading end of the transfer material P moves in a shortest distance between the secondary transfer portion N2 and the feeding belt 42 after passing through the secondary transfer portion N2.

Further, in this embodiment, the discharging needle voltage is changed between 0 V (or the grounding state) and a predetermined discharging voltage value of the identical polarity to the charge polarity of the toner on the intermediary transfer belt 1, but is not limited thereto. Depending on behavior (degree of floating) of the transfer material P on a free end side, or the like, the discharging needle voltage made 0 V (or the grounding state) in this embodiment may also be made a voltage which is smaller in absolute value than the above-described final discharging voltage value and which has the identical polarity to the charge polarity of the toner on the intermediary transfer belt 1. This voltage which is smaller in absolute value than the final discharging voltage value and which has the identical polarity to the charge polarity of the toner on the intermediary transfer belt 1 is also referred herein to as “weakly negative voltage”.

Specifically, in a period in which the leading end of the transfer material P discharged from the secondary transfer portion N2 moves in the distance L6 from the secondary transfer portion N2 to the fixing portion N3, the discharging needle voltage can be made 0 to −0.5 kV, preferably 0 to −0.25 kV. Incidentally, in the case where such a weakly negative voltage is applied, a difference thereof with a discharging voltage applied after the leading end of the transfer material P moved in the distance L6 from the secondary transfer portion N2 to the fixing portion N3 as described above may preferably be not less than 200 V. Further, when the transfer material P does not exist between the secondary transfer portion N2 and the fixing portion N3, the discharging needle voltage is made 0 V or the discharging needle 5 is placed in the grounding state. This is for the following reason. Although described above using FIG. 6, when the voltage of the negative polarity is applied to the discharging needle 5 in a state in which the transfer material P is charged to the negative polarity, the transfer material P and the discharging needle 5 are electrostatically repelled by each other and the transfer material P floats as shown in part (b) of FIG. 6. In such a state, ideally, it is preferable that the voltage of the negative polarity is not applied to the discharging needle 5. However, there is also a case that depending on a curled state or a wavy state of the leading end of the transfer material P, the transfer material P is likely to be separated from the intermediary transfer belt 1 and is charged to the positive polarity. For that reason, when the voltage of the negative polarity is applied to the discharging needle 5 at a level at which the transfer material P does not float, the positive polarity electric charges which are likely to become excessive can be alleviated. Further, in order to discharge (remove) the negative polarity electric charges of the transfer material P or the like purpose, in this embodiment, the discharging needle voltage made 0 V (or the grounding state) may also be changed to a voltage of the positive polarity (see, Embodiment 2). Further, timing when the above-described weakly negative voltage or the voltage of the positive polarity is applied to the discharging needle may only be required to coincide with timing when the leading end of the transfer material P is closest to the discharging needle 5.

Thus, typically, in the period in which the leading end of the transfer material P moves in the predetermined distance from the secondary transfer portion N2 toward the fixing portion N3, the voltage applied from the discharging voltage source E3 to the discharging needle 5 is made 0 V or the discharging needle 5 is electrically grounded. However, in this period, from the discharging voltage source E3 to the discharging needle 5, a voltage of the identical polarity or opposite polarity to the normal charge polarity of the toner can also be applied.

As described hereinabove, according to this embodiment, the discharging needle voltages for a portion of the transfer material P on the leading end side and a portion of the transfer material P on the trailing end side are made different from each other. By this, a discharging process can be optimized depending on a charging state of the transfer material P from the leading end to the trailing end of the transfer material P. For that reason, disturbance of the toner image at the depending on of the transfer material P on the trailing end side can be alleviated, and feeding behavior of the transfer material P can be stabilized by suppressing floating of the transfer material P at the portion of the transfer material P on the leading end side.

Next, another embodiment of the present invention will be described. Basic constitutions and operations of an image forming apparatus in this embodiment are the same as those of the image forming apparatus in Embodiment 1. Accordingly, in the image forming apparatus in this embodiment, elements having the same or corresponding functions and constitutions as those in the image forming apparatus in Embodiment 1 are represented by the same reference numerals or symbols as those in Embodiment 1 and will be omitted from detailed description.

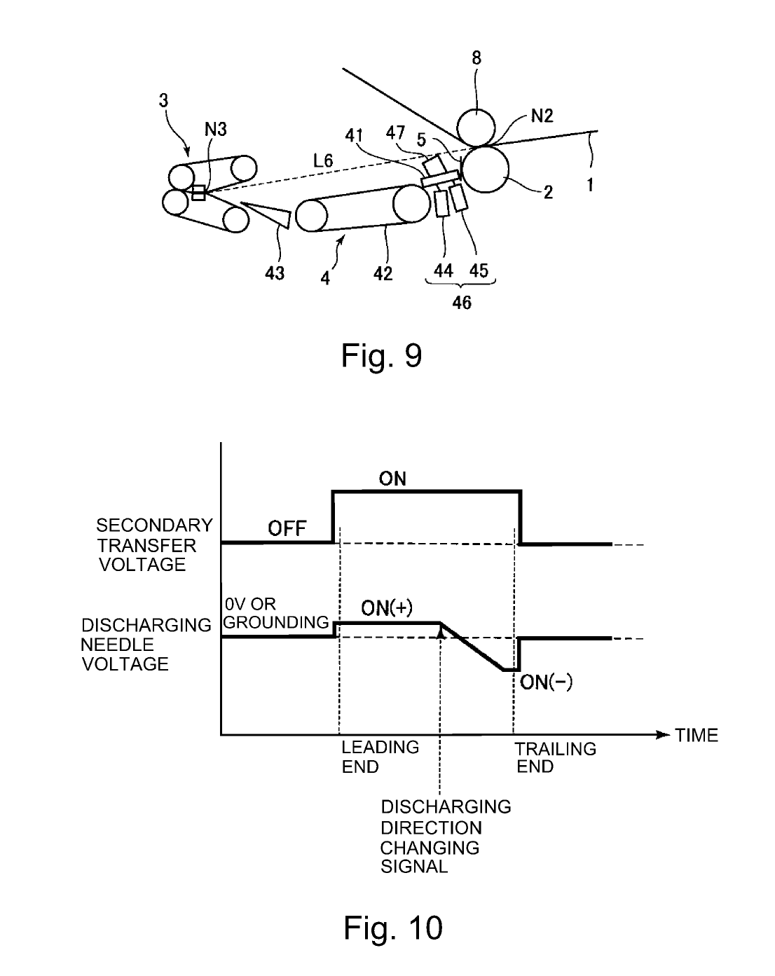

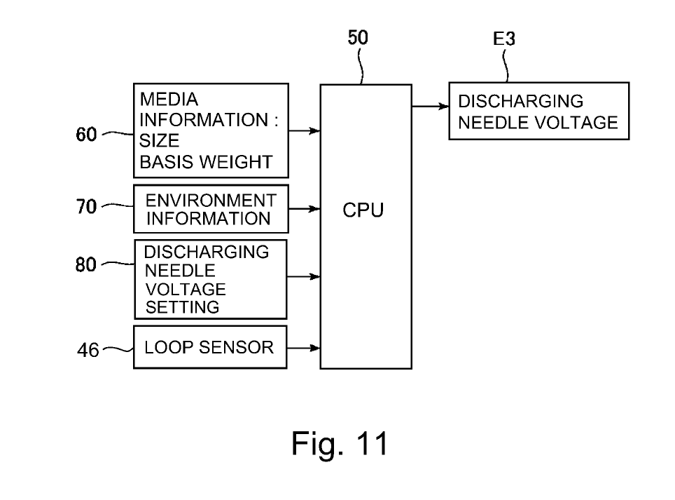

FIG. 9 is a sectional view of a neighborhood of the pre-fixing feeding portion 4 in this embodiment as seen in a direction (rotational axis directions of the photosensitive drum 1 and the stretching rollers for the intermediary transfer belt 1) substantially perpendicular to the feeding direction of the transfer material P. FIG. 10 is a timing chart of the voltage (secondary transfer voltage) applied to the secondary transfer roller 5 and the voltage (discharging needle voltage) applied to the discharging needle 5 in this embodiment. Further, FIG. 11 is a block diagram showing a schematic control mode of the discharging needle voltage in this embodiment.

In this embodiment, the image forming apparatus 100 includes a loop sensor 46 as a detecting means for detecting a position (herein referred to as an “up-down position”), with respect to a direction crossing a surface of the transfer material P, of the transfer material P fed from the secondary transfer portion N2 toward the fixing portion N3. Further, the CPU 50 changes, depending on a detection result of the loop sensor 46, timing when the discharging needle voltage is changed as described in Embodiment 1.

In this embodiment, the loop sensor 4 is constituted by including photo-interrupters 44 and 45 which are provided below the front guide 41 and including a loop detection flag 47 inclined in contact with a back surface of the transfer material P. The loop sensor 46 detects that the loop detection flag 47 is inclined to a predetermined angle by the photo-interrupters 44 and 45. This corresponds to detection that the up-down position of the transfer material P approaches the intermediary transfer belt 1 side (image bearing member side) by not less than a predetermined value. When the loop sensor 46 detects that the loop flag 47 is inclined to the above-described predetermined angle, the loop sensor 46 changes a discharging direction changing signal from OFF to ON. The CPU 50 can discriminate that when the discharging direction changing signal is changed from OFF to ON, the discharging direction of the transfer material P from the secondary transfer portion N2 is changed as shown in parts (b) and (c) of FIG. 5 and the transfer material P is oriented toward the intermediary transfer belt 1.

In this embodiment, in a period of OFF of the discharging direction charging signal after the leading end of the transfer material P discharged from the secondary transfer portion N2 passes through the secondary transfer portion N2, the voltage of the positive polarity is applied to the discharging needle 5. This is suitable in the case where the transfer material P is liable to be discharged downwardly. As described, the transfer material P discharged downwardly is easily charged to the negative polarity, and therefore, the electric charges are attenuated by applying the voltage of the positive polarity to the discharging needle 5, so that electric discharge during separation of the transfer material P is suppressed and the image disturbance can be alleviated, in this embodiment, when the transfer material P does not exist between the secondary transfer portion N2 and the fixing portion N3, the discharging needle voltage is made 0 V or the discharging needle 5 is placed in the grounding state. Further, typically, timing when the discharging direction changing signal is changed from OFF to ON is after the leading end of the transfer material P discharged from the secondary transfer portion N2 moves in the distance L6 from the secondary transfer portion N2 to the fixing portion N3. When the discharging direction changing signal is changed from OFF to ON, the discharging needle voltage is stepwisely changed every feeding distance of 5-15 mm of the transfer material P toward a negative polarity discharging voltage value which is determined in advance as described later. Then, the discharging needle voltage is finally changed to the discharging voltage value. Thus, in this embodiment, in the case where detection that the up-down position of the transfer material P approached the intermediary transfer belt 1 side by not less than the predetermined value was made by the loop sensor 46, the discharging needle voltage is changed as described in Embodiment 1. In other words, in the case where detection that the up-down position of the transfer material P reached a predetermined position was made by the loop sensor 46, the CPU 50 switches the discharging needle potential as described in Embodiment 1. Further, after the trailing end of the transfer material P passed through the secondary transfer portion N2, the discharging needle voltage is made 0 V or the discharging needle 5 is placed in the grounding state.

The reason why the discharging needle voltage is gradually changed is as follows. That is, a neighborhood of a point of time when the discharging direction changing signal is changed to ON is timing when the charging state of the transfer material P is changed from a negative polarity state to a positive polarity state. For that reason, the behavior of the transfer material P can stabilize when the discharging needle voltage is gradually changed toward a final discharging voltage value as in this embodiment more than when the discharging needle voltage is switched to the final discharging voltage value in a step function manner.

Table 2 shows setting of the discharging needle voltage in this embodiment. In this embodiment, similarly as in Embodiment 1, the final discharging voltage value is changed depending on an environment (absolute water content in this embodiment), a basis weight of the transfer material P and whether an image formation side (surface) is a first side (surface) or a second side (surface). This is for the same reason as that described in Embodiment 1.

TABLE 2

| | | | | Environment | | |
|---|---|---|---|---|---|---|
| | | | | NL | NN | HH |
| | | | | Temperature (° C.) | | |
| | | | | 23° C. | 23° C. | 30° C. |
| | | | | Humidity (%) | | |
| | | | | 5% | 50% | 80% |
| | | | | Absolute Water Content | | |
| | | | | (g/kg—DryAir) | | |
| | | | | 0.907 g | 9.184 g | 22.734 g |
| Basis | 52-127 | 1ST | DDCS*: OFF | +1.0 kV | +0.7 kV | +0.5 kV |
| Wight | | Side | DDCS*: ON | −2 kV | −1.5 kV | −1.0 kV |
| (g/m²) | | 2ND | DDCS*: OFF | +1.25 kV | +1.0 kV | +0.7 kV |
| | | Side | DDCS*: ON | −2.5 kV | −2.0 kV | −1.5 kV |
| | 128-300 | 1ST | DDCS*: OFF | +0.7 kV | +0.5 kV | +0.25 kV |
| | | Side | DDCS*: ON | −1.5 kV | −1.0 kV | −0.5 kV |
| | | 2ND | DDCS*: OFF | +1.0 kV | +0.7 kV | +0.5 kV |
| | | Side | DDCS*: ON | −2 kV | −1.5 kV | −1.0 kV |

*: “DDCS” is a discharging direction change signal.

Incidentally, in this embodiment, the voltage of the positive polarity was applied to the discharging needle 5 in the period of OFF of the discharging direction changing signal after the leading end of the transfer material P passed through the secondary transfer portion N2, but similarly as in Embodiment 1, in this period, the discharging needle voltage may also be made 0 V (or the grounding state).

Further, the absolute value of the final discharging voltage can also be changed depending on a detection result of the loop sensor 46. Typically, as the up-down position of the transfer material P is a position closer to the intermediary transfer belt 1 side, the absolute value of the discharging voltage of the identical polarity to the charge polarity of the toner on the intermediary transfer belt 1 can be made large. By this, the disturbance of the toner image can be effectively suppressed depending on the up-down position of the transfer material P. That is, typically, an absolute value of the discharging voltage in the case where the up-down position is a second position closer to the intermediary transfer belt 1 than a first position is can be made larger than an absolute value of the discharging voltage in the case where the up-down position is the first position.

As described above, according to this embodiment, the up-down position of the transfer material P is detected by the loop sensor 46, so that the discharging needle voltage is controlled in accordance with actual behavior of the transfer material P, and the toner image disturbance and the floating of the transfer material P can be effectively suppressed.

### [Others]

As described above, the present invention was described in accordance with specific embodiments, but the present invention is not limited to the above-described embodiments.

In the above-described embodiments, with respect to the behavior of the transfer material P between the secondary transfer portion and the fixing portion in the image forming apparatus of the intermediary transfer type, the present invention was applied but is not limited thereto. As is well known by the person skilled in the art, there is an image forming apparatus in which the toner image is directly transferred from the image bearing member such as the photosensitive member onto the transfer material at the transfer portion. Also in this case, the discharging member is provided in the neighborhood of a side downstream of the transfer portion in some instances. Accordingly, also with regard to behavior of the transfer material between the transfer portion and the fixing portion in such an image forming apparatus, the present invention can be applied, and effects similar to those of the above-described embodiments can be obtained. Further, the image bearing member may also be an electrostatic recording dielectric member if the member carriers the toner image.

Further, in the above-described embodiments, the transfer member (secondary transfer member) was the rotatable roller-shaped member, but is not limited thereto, and may also be those having a rotatable endless belt shape, a rotatable or a fixedly arranged type brush shape, a sheet shape, and a blade shape. However, typically, the transfer member is a rotatable member for feeding the transfer material while sandwiching the transfer material between itself and the image bearing member.

### INDUSTRIAL APPLICABILITY

According to the present invention, there is provided an image forming apparatus capable of stabilizing feeding behavior of a transfer material while suppressing disturbance of a toner image due to electric discharge.

### EXPLANATION OF SYMBOLS

1: intermediary transfer belt
2: secondary transfer roller
3: fixing device
4: pre-fixing feeding portion
5: discharging needle
50: CPU
100: image forming apparatus
E3: discharging voltage source

1. An image forming apparatus comprising:
an image bearing member for bearing a toner image;
an intermediary transfer belt onto which the toner image is to be transferred from said image bearing member;
a transfer member for forming a transfer portion for transferring the toner image from said intermediary transfer belt onto a transfer material under application of a voltage;
a fixing device including a fixing portion for fixing the toner image, transferred on the transfer material, on the transfer material;
a discharging member, provided downstream of said transfer portion and upstream of said fixing portion with respect to a transfer material feeding direction, for discharging a surface of the transfer material;
a voltage source for applying a voltage to said discharging member; and
a controller for controlling said voltage source,
wherein a feeding speed of the transfer material at said fixing portion is set so as to be slower than a feeding speed of the transfer material at said transfer portion, and
wherein in a case that an image is formed on a specific transfer material which has a basis weight not more than a predetermined value and which has a length, with respect to the transfer material feeding direction, not less than a predetermined length longer than a feeding distance of the transfer material from said transfer portion to said fixing portion,
said controller executes an operation in a mode for controlling the voltage applied to said discharging member so that a potential of said discharging member, in a period from predetermined timing, after first timing when a leading end of the specific transfer material with respect to the feeding direction reaches said fixing portion and before second timing when an amount of a loop of the specific transfer material formed between said fixing portion and said transfer portion after the leading end of the specific transfer material with respect to the feeding direction reaches said fixing portion reaches a predetermined amount, to third timing when a trailing end of the specific transfer material passes through said transfer portion, is identical in polarity to a charge polarity of toner and so that an absolute value of the potential is made larger than an absolute value of a potential of said discharging member applied in a period from passing of the leading end of the specific transfer material with respect to the feeding direction through said transfer portion to the predetermined timing.

2. An image forming apparatus according to claim 1, wherein said controller causes the voltage applied from said voltage source to said discharging member to be 0 V or causes said discharging member to be grounded, in a period from passing of the leading end of said specific transfer material with respect to the feeding direction through said transfer portion until the leading end of said specific transfer material reaches said fixing portion.

3. An image forming apparatus according to claim 1, where said controller causes the voltage applied from said voltage source to said discharging member to be identical in polarity to the charge polarity of the toner and causes an absolute value of the voltage to gradually increase, in a period from after the leading end of said specific transfer material with respect to the feeding direction reaches said fixing portion until the trailing end of the specific transfer material with respect to the feeding direction passes through said transfer portion.

4. An image forming apparatus according to claim 1, further comprising detecting means for detecting a position of the transfer material, fed from said transfer portion to said fixing portion, with respect to a direction crossing a surface of the transfer material,
wherein said controller changes the predetermined timing depending on a detection result of said detecting means.

5. An image forming apparatus according to claim 1, further comprising detecting means for detecting a position of the transfer material, fed from said transfer portion to said fixing portion, with respect to a direction crossing a surface of the transfer material,
wherein said controller changes, depending on a detection result of said detecting means, an absolute value of a potential of said discharging member in a period from the predetermined timing to the third timing.

6. An image forming apparatus according to claim 5, wherein said controller causes the absolute value of the potential of said discharging member in the period from the predetermined timing to the third timing in a case that the position is a second position closer to said image bearing member than a first position is to be larger than the absolute value of the potential of said discharging member in the period from the predetermined timing to the third timing in a case that the position is the first position.

7. An image forming apparatus comprising:
an image bearing member for bearing a toner image;
an intermediary transfer belt onto which the toner image is to be transferred from said image bearing member;
a transfer member for forming a transfer portion for transferring the toner image from said intermediary transfer belt onto a transfer material under application of a voltage;
a fixing device including a fixing portion for fixing the toner image, transferred on the transfer material, on the transfer material;
a discharging member, provided downstream of said transfer portion and upstream of said fixing portion with respect to a transfer material feeding direction, for discharging a surface of the transfer material;
a voltage source for applying a voltage to said discharging member; and
a controller for controlling said voltage source; and
detecting means for detecting a position of the transfer material, fed from said transfer portion to said fixing portion, with respect to a direction crossing a surface of the transfer material,
wherein in a case that said detecting means detected that the position approached said image bearing member by not less than a predetermined value in a period from passing of a leading end of the transfer material with respect to the feeding direction through said transfer portion until a trailing end of the transfer material with respect to the feeding direction passes said transfer portion, said controller controls the voltage applied to said discharging member so that the voltage applied to said discharging member is identical in polarity to a charge polarity of toner and so that an absolute value of the voltage is made larger than an absolute value of a potential of said discharging member applied in a period from passing of the leading end of the specific transfer material with respect to the feeding direction through said transfer portion until said detecting means detects that the position approached said image bearing member by not less than the predetermined value.

8. An image forming apparatus comprising:
an image bearing member for bearing a toner image;
an intermediary transfer belt onto which the toner image is to be transferred from said image bearing member;
a transfer member for forming a transfer portion for transferring the toner image from said intermediary transfer belt onto a transfer material under application of a voltage;
a fixing device including a fixing portion for fixing the toner image, transferred on the transfer material, on the transfer material;
a discharging member, provided downstream of said transfer portion and upstream of said fixing portion with respect to a transfer material feeding direction, for discharging a surface of the transfer material;
a feeding belt, provided downstream of said discharging member and upstream of said fixing portion with respect to the transfer material feeding direction, for feeding the transfer material while attracting the transfer material to a surface thereof;
a voltage source for applying a voltage to said discharging member; and
a controller for controlling said voltage source,
wherein a feeding speed of the transfer material by said feeding belt is set so as to be slower than a feeding speed of the transfer material at said transfer portion, and
wherein in a case that an image is formed on a specific transfer material which has a basis weight not more than a predetermined value and which has a length, with respect to the transfer material feeding direction, not less than a predetermined length longer than a feeding distance of the transfer material from said transfer portion to said fixing portion,
said controller executes an operation in a mode for controlling the voltage applied to said discharging member so that a potential of said discharging member, in a period from predetermined timing, after first timing when a leading end of the specific transfer material with respect to the feeding direction is attracted to said feeding belt and before second timing when an amount of a loop of the specific transfer material formed between said fixing portion and said transfer portion after the leading end of the specific transfer material with respect to the feeding direction reaches said fixing portion reaches a predetermined amount, to third timing when a trailing end of an image region of the specific transfer material passes through said transfer portion, is identical in polarity to a charge polarity of toner and so that an absolute value of the potential is made larger than an absolute value of a potential of said discharging member applied in a period from passing of the leading end of the specific transfer material with respect to the feeding direction through said transfer portion to the predetermined timing.

9. An image forming apparatus according to claim 8, wherein said controller causes the voltage applied from said voltage source to said discharging member to be 0 V or causes said discharging member to be grounded, in a period from passing of the leading end of said specific transfer material with respect to the feeding direction through said transfer portion until the leading end of said specific transfer material reaches said feeding belt.

10. An image forming apparatus according to claim 8, wherein said controller controls the voltage applied to said discharging member so that the potential of said discharging member is made identical in polarity to the charge polarity of the toner in the period from the passing of the leading end of said specific transfer material with respect to the feeding direction through said transfer portion until the leading end of said specific transfer material reaches said feeding belt.

11. An image forming apparatus according to claim 8, where said controller causes the voltage applied from said voltage source to said discharging member to be identical in polarity to the charge polarity of the toner and causes an absolute value of the voltage to gradually increase, in a period from after the leading end of said specific transfer material with respect to the feeding direction reaches said feeding belt until the trailing end of the image region of the specific transfer material with respect to the feeding direction passes through said transfer portion.

12. An image forming apparatus according to claim 8, wherein said predetermined timing is after the leading end of said specific transfer material reaches said fixing portion.

13. An image forming apparatus according to claim 8, further comprising a backing-up roller, provided in contact with an inner surface of said intermediary transfer belt and opposing said transfer material while sandwiching said intermediary transfer belt between itself and said transfer member, for forming said transfer portion,
wherein an outer diameter of said back-up roller is smaller than an outer diameter of said transfer member.

14. An image forming apparatus according to claim 8, further comprising detecting means for detecting a position of the transfer material, fed from said transfer portion to said fixing portion, with respect to a direction crossing a surface of the transfer material,
wherein said controller changes the predetermined timing depending on a detection result of said detecting means.

15. An image forming apparatus according to claim 14, wherein in a case that detecting means detected that the position reached the predetermined position, said controller switches the potential of said discharging member from a potential in a period from the passing of the leading end of the specific transfer material with respect to the feeding direction through said transfer portion to the predetermined timing to a potential in a period from the predetermined timing to the third timing.

16. An image forming apparatus according to claim 8, further comprising detecting means for detecting a position of the transfer material, fed from said transfer portion to said fixing portion, with respect to a direction crossing a surface of the transfer material,
wherein said controller changes, depending on a detection result of said detecting means, an absolute value of a potential of said discharging member in a period from the predetermined timing to the third timing.

17. An image forming apparatus according to claim 16, wherein said controller causes the absolute value of the potential of said discharging member in the period from the predetermined timing to the third timing in a case that the position is a second position closer to said image bearing member than a first position is to be larger than the absolute value of the potential of said discharging member in the period from the predetermined timing to the third timing in a case that the position is the first position.

18. An image forming apparatus comprising:
an image bearing member for bearing a toner image;
an intermediary transfer belt onto which the toner image is to be transferred from said image bearing member;
a transfer member for forming a transfer portion for transferring the toner image from said intermediary transfer belt onto a transfer material under application of a voltage;
a fixing device including a fixing portion for fixing the toner image, transferred on the transfer material, on the transfer material;
a discharging member, provided downstream of said transfer portion and upstream of said fixing portion with respect to a transfer material feeding direction, for discharging a surface of the transfer material;
a feeding belt, provided downstream of said discharging member and upstream of said fixing portion with respect to the transfer material feeding direction, for feeding the transfer material while attracting the transfer material to a surface thereof;
a guiding portion, provided downstream of said discharging member and upstream of said feeding belt with respect to the transfer material feeding direction and constituted by metal which is grounded, for guiding the transfer material;
a voltage source for applying a voltage to said discharging member; and
a controller for controlling said voltage source,
wherein a feeding speed of the transfer material by said feeding belt is set so as to be slower than a feeding speed of the transfer material at said transfer portion, and
wherein in a case that an image is formed on a specific transfer material which has a basis weight not more than a predetermined value and which has a length, with respect to the transfer material feeding direction, not less than a predetermined length longer than a feeding distance of the transfer material from said transfer portion to said fixing portion,
said controller executes an operation in a mode for controlling the voltage applied to said discharging member so that a potential of said discharging member, in a period from predetermined timing, after first timing when a leading end of the specific transfer material with respect to the feeding direction reaches said guiding portion and before second timing when an amount of a loop of the specific transfer material formed between said fixing portion and said transfer portion after the leading end of the specific transfer material with respect to the feeding direction reaches said fixing portion reaches a predetermined amount, to third timing when a trailing end of an image region of the specific transfer material passes through said transfer portion, is identical in polarity to a charge polarity of toner and so that an absolute value of the potential is made larger than an absolute value of a potential of said discharging member applied in a period from passing of the leading end of the specific transfer material with respect to the feeding direction through said transfer portion to the predetermined timing.
